(19) United States
(12) Patent Application Publication
(10) Pub. No.: US 2008/0291345 A1
(43) Pub. Date: Nov. 27, 2008

(54) PICTURE FRAME ANTENNA ASSEMBLIES

(75) Inventor: Richard E. Schneider, Wildwood, MO (US)

Correspondence Address: HARNESS, DICKEY, & PIERCE, P.L.C, 7700 Bonhomme, Suite 400, ST. LOUIS, MO, 63105, US

(73) Assignee: ANTENNAS DIRECT, INC., Eureka, MO (US)

(21) Appl. No.: 12/126,593

(22) Filed: May 23, 2008

Related U.S. Application Data
(60) Provisional application No. 60/931,448, filed on May 23, 2007.

(51) Int. Cl. H04N 5/64

(52) U.S. Cl. 348/836; 348/E05.128

(57) ABSTRACT

According to various aspects of the present disclosure, exemplary embodiments are provided of picture frame antenna assemblies. In one exemplary embodiment, an assembly generally includes a backing defining at least one recess. A frame is removably attachable to the backing for holding a photograph therebetween. The frame has a generally annular shape with an opening through which a portion of the photograph is visible. At least one antenna element is disposed within the recess defined by the backing.

### CROSS-REFERENCE TO RELATED APPLICATION

This application claims the benefit of U.S. Provisional Application No. 60/931,448 filed May 23, 2007. The entire closure of the provisional application is incorporated herein by reference in its entirety.

### FIELD

The present disclosure relates to picture frame antenna assemblies.

### BACKGROUND

This section provides background information related to the present disclosure which is not necessarily prior art.

People enjoy collecting, displaying, and viewing photographs of their family, friends, pets, as well as diplomas, artwork, etc. It is often convenient to use photo frames to display pictures in homes and offices.

Another activity many people enjoy is watching television. Recently, the television experience has been greatly improved due to the arrival of high definition television (HDTV). A great number of people pay for HDTV through their existing cable or satellite TV service provider. In fact, many people are unaware that HDTV signals are commonly broadcast over the free public airwaves. This means that HDTV signals may be received for free with the appropriate antenna. As recognized by the inventor hereof, existing HDTV antennas are usually designed for outdoor use, and those designed for indoor use are visually unattractive and obtrusive.

### SUMMARY

This section provides a general summary of the disclosure, and is not a comprehensive disclosure of its full scope or all of its features.

According to various aspects of the present disclosure, exemplary embodiments are provided of picture frame antenna assemblies. In one exemplary embodiment, an assembly generally includes a backing defining at least one recess. A frame is removably attachable to the backing for holding a photograph therebetween. The frame has a generally annular shape with an opening through which a portion of the photograph is visible. At least one antenna element is disposed within the recess defined by the backing.

Another exemplary embodiment provides an assembly suitable for displaying a photograph and operable for receiving signals. In this exemplary embodiment, the assembly generally includes a backing and at least one photomount coupled to the backing. At least one antenna element is disposed generally between the backing and the photomount.

Other aspects relate to methods of making and using picture frame antennas. Various embodiments relate to methods of displaying a photograph and receiving high definition television signals. In one such embodiment, a method generally includes positioning a photograph generally between a frame and a backing. The frame may be removably attached to the backing. A communication link may be connected to a television for communicating signals to the television that are received by at least one antenna element disposed within at least one recessed portion of the backing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure in any way.

FIG. 1 is a front exploded perspective of an exemplary embodiment of a picture frame antenna;

FIG. 2 is a back exploded perspective of the picture frame antenna shown in FIG. 1;

FIG. 3 is a front perspective view illustrating the picture frame antenna shown in FIG. 1 after it has been assembled;

FIG. 4 is a back perspective view of the picture frame antenna shown in FIG. 3;

FIG. 5 is a front view of the picture frame antenna shown in FIG. 3;

FIG. 6 is a left side view of the picture frame antenna shown in FIG. 3;

FIG. 7 is a right side view of the picture frame antenna shown in FIG. 3;

FIG. 8 is a top view of the picture frame antenna shown in FIG. 3;

FIG. 9 is bottom view of the picture frame antenna shown in FIG. 3;

FIG. 10 is a back view of the picture frame antenna shown in FIG. 3;

FIG. 11 is a front perspective view of the backing and antenna elements shown in FIG. 1 but further illustrating the antenna elements disposed within the recessed portions of the backing;

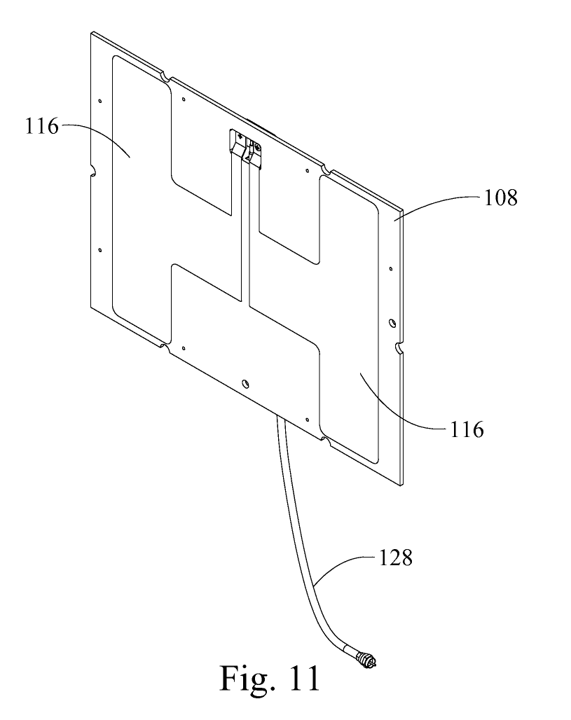

FIG. 12 is a front view of the backing and antenna elements shown in FIG. 11;

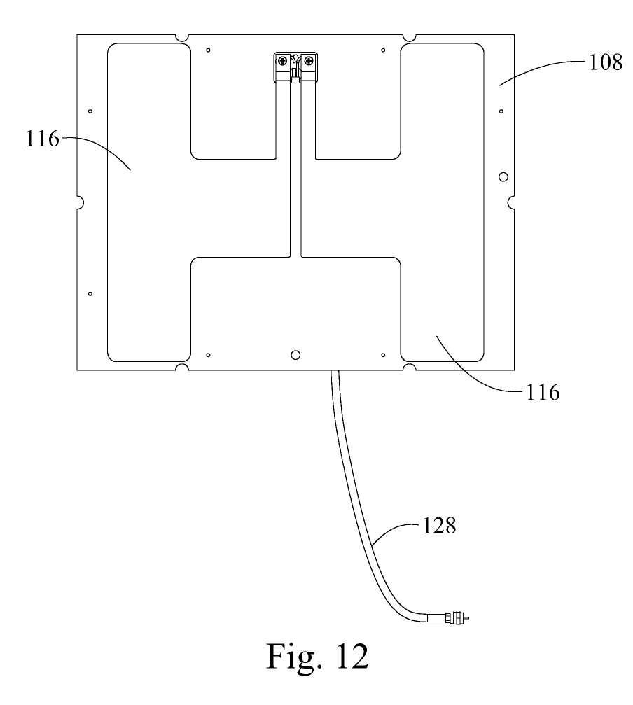

FIG. 13 is a top view of the backing and antenna elements shown in FIG. 11;

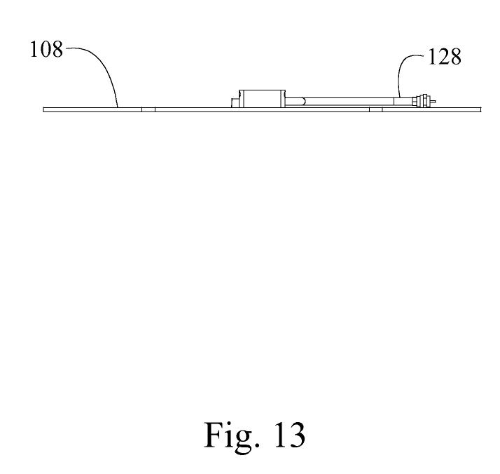

FIG. 14 is a left side view of the backing and antenna elements shown in FIG. 11;

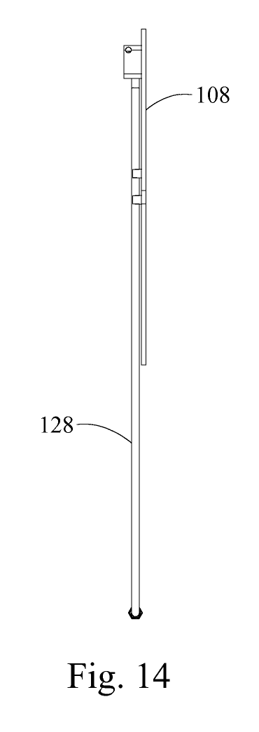

FIG. 15 is a right side view of the backing and antenna elements shown in FIG. 11;

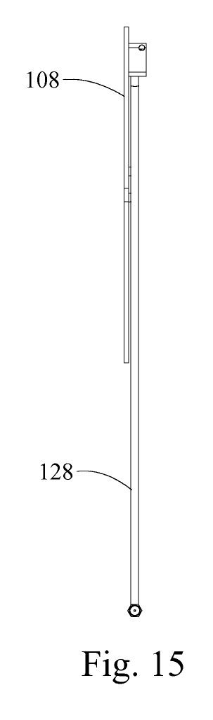

FIG. 16 is a bottom view of the backing and antenna elements shown in FIG. 11;

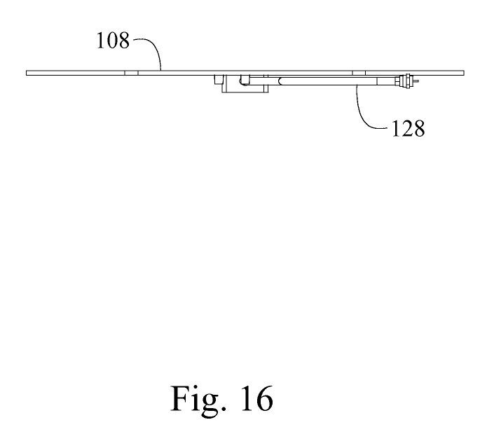

FIG. 17 is a back view of the backing and antenna elements shown in FIG. 11;

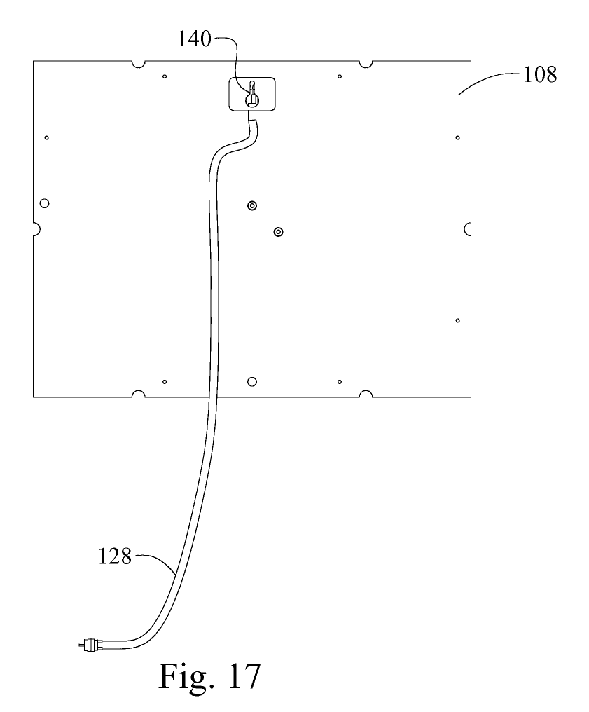

FIG. 18 is a front perspective view of the backing and antenna elements shown in FIG. 11 but further illustrating the adhesive layer coupled thereto for helping retain and conceal the antenna elements within the recessed portions of the backing;

FIG. 19 is a perspective view illustrating an exemplary use for the picture frame antenna shown in FIG. 3 with the picture frame antenna supported on top of a television via the deployed easel with a coaxial cable connecting the picture frame antenna to the television whereby the picture frame antenna is operable for receiving UHF digital television signals and providing the same to the television via the coaxial cable;

FIG. 20 is a perspective view illustrating an exemplary use for the picture frame antenna shown in FIG. 3 with the picture frame antenna mounted to a wall with a coaxial cable connecting the picture frame antenna to a television whereby the picture frame antenna is operable for receiving UHF digital television signals and providing the same to the television via the coaxial cable;

FIG. 21 is a front exploded perspective of another exemplary embodiment of a picture frame antenna with a different frame configuration;

FIG. 22 is a computational model illustrating a transient field snapshot for the antenna elements of an exemplary embodiment of the picture frame antenna; and

FIG. 23 is an exemplary line graph of the gain and S11 versus frequency for an exemplary embodiment of the picture frame antenna with seventy-five ohm balanced feed.

Corresponding reference numerals indicate corresponding parts throughout the several views of the drawings.

### DETAILED DESCRIPTION

In the following description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill.

In order to provide an aesthetically pleasing and unobtrusive antenna that may be used indoors for receiving signals, the inventor hereof has developed various embodiments of picture frame antenna assemblies. In some exemplary embodiments, an HDTV antenna is incorporated into or combined with a picture frame in an manner such that the HDTV antenna is operable for receiving HDTV signals while the HDTV antenna remains concealed and hidden from view. Plus, the assembly may also be used to display photographs, artwork, diplomas, etc. Accordingly, various embodiments of the picture frame antenna assemblies disclosed herein have dual functionality, e.g., receiving HDTV signals and displaying photographs, etc.

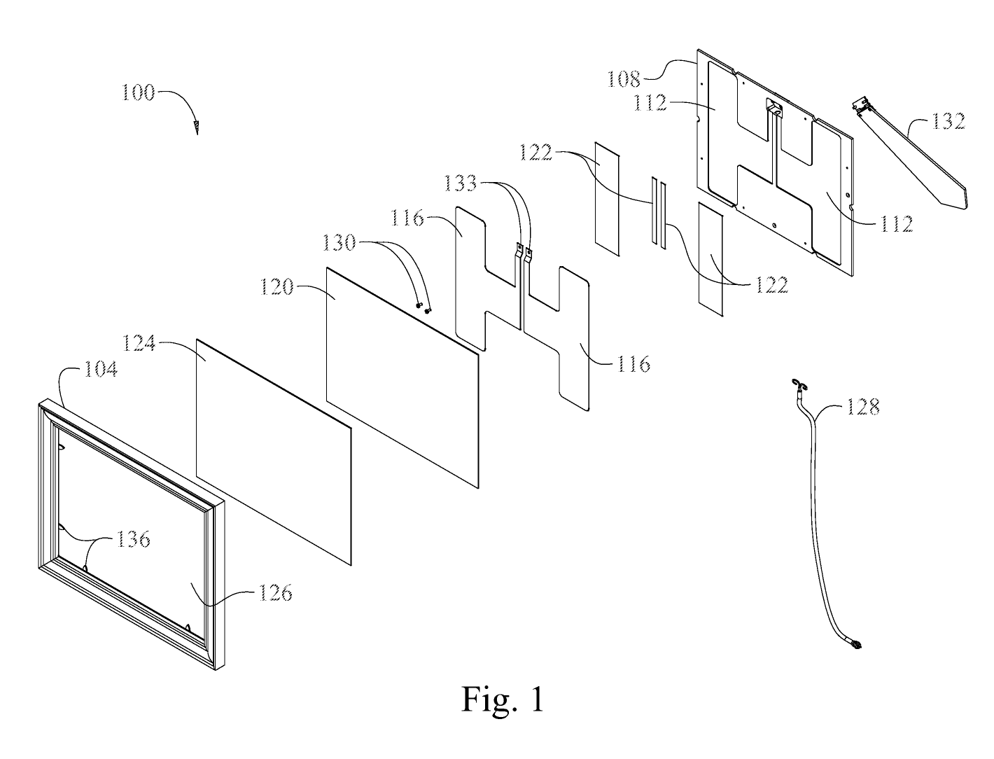

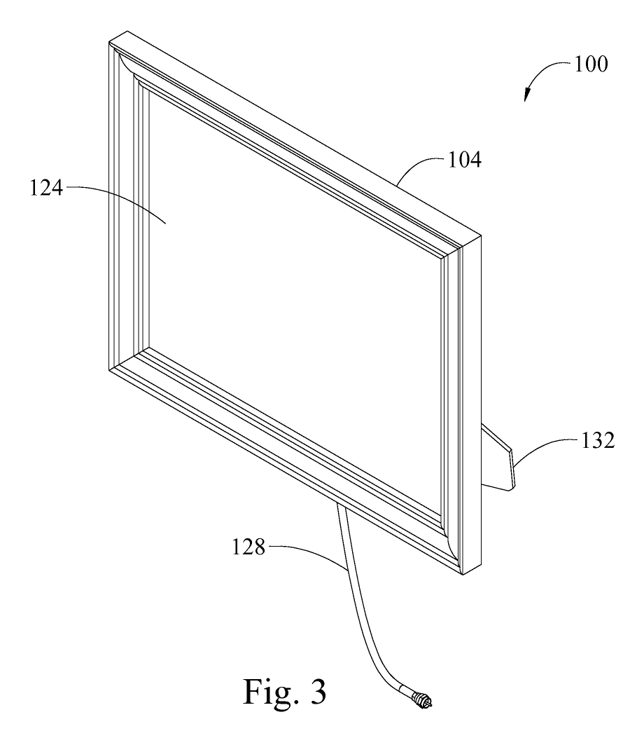

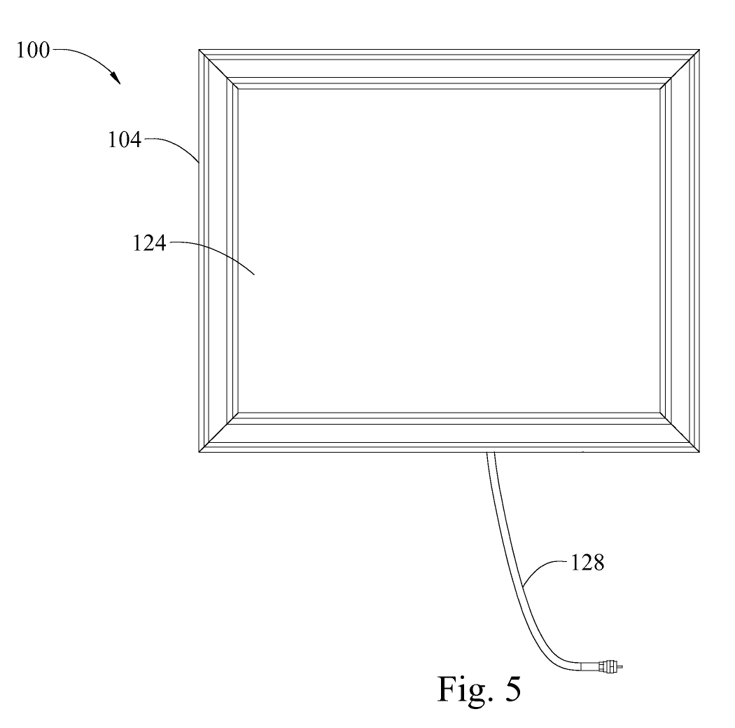

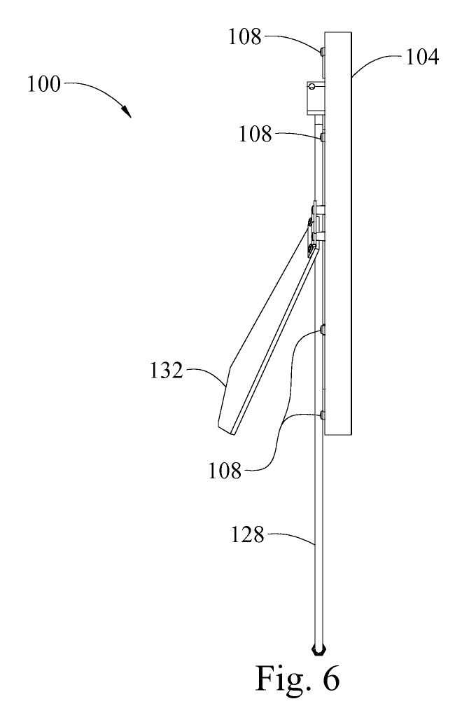

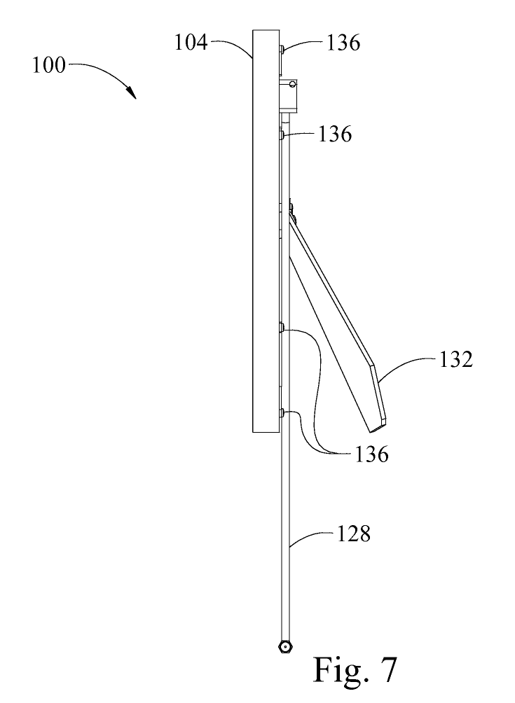

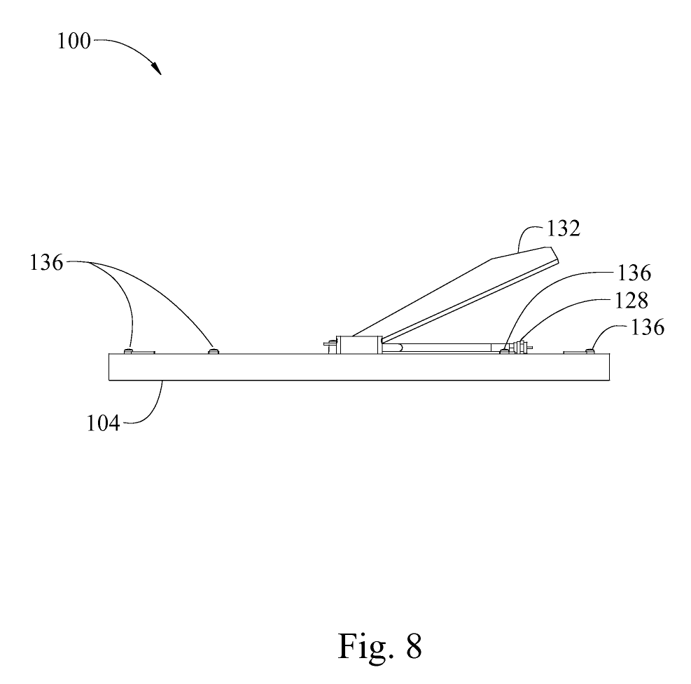

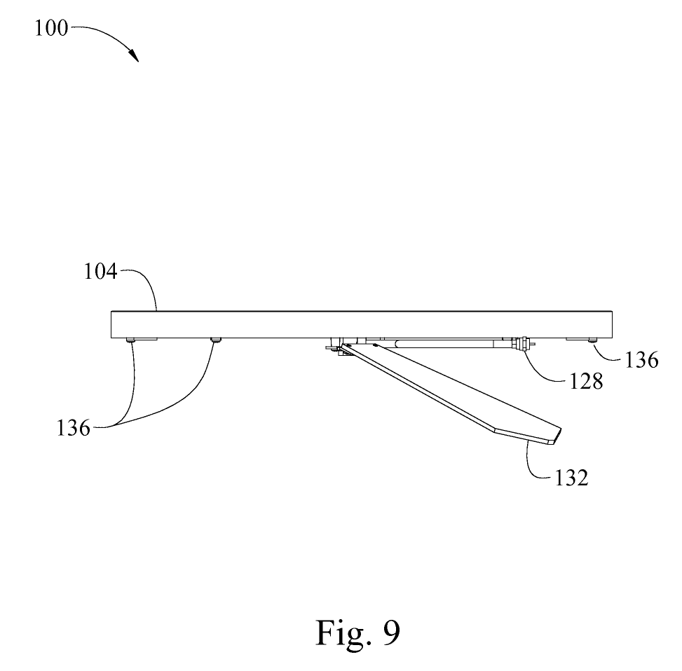

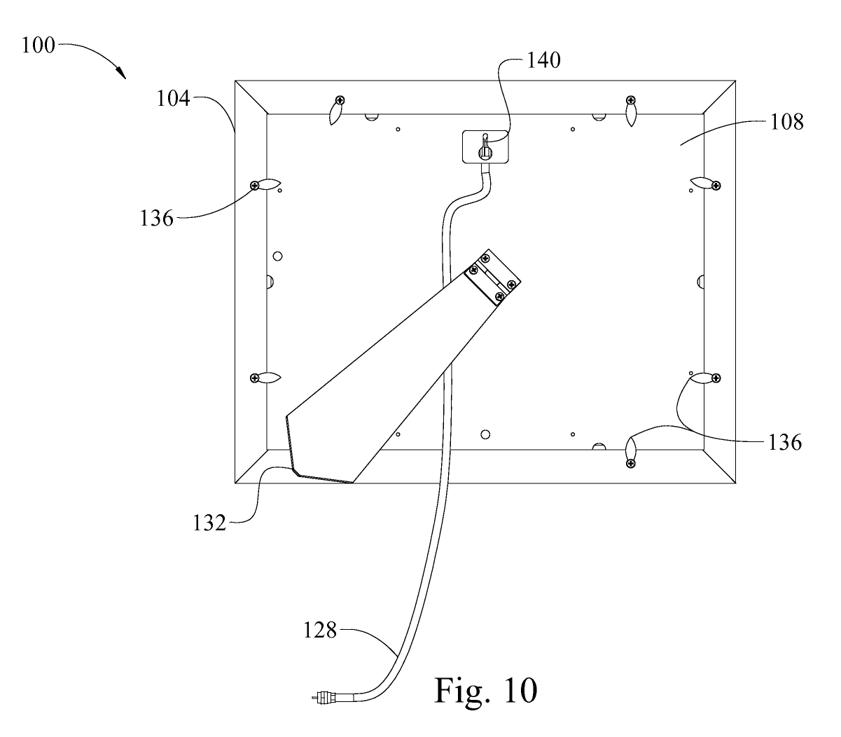

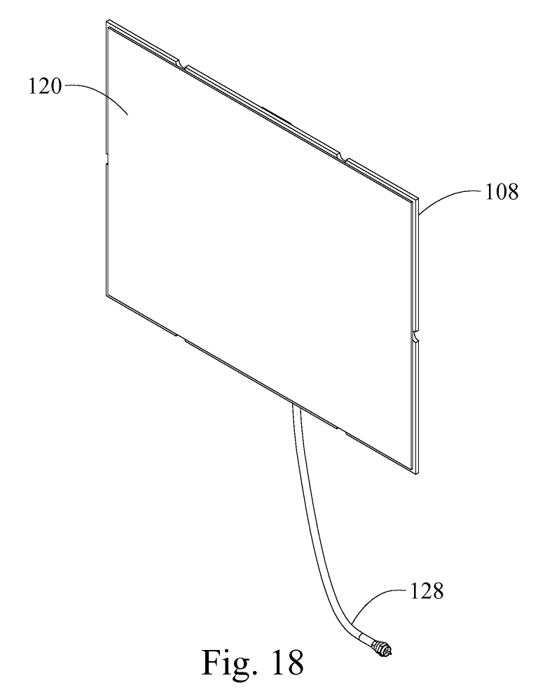

FIGS. 1 through 10 illustrate an exemplary picture frame antenna assembly 100 embodying one or more aspects of the present disclosure. As shown in FIG. 1, the assembly 100 includes a frame 104, a backing 108 with recesses 112, antenna elements 116 configured to be disposed within the recesses 112, an adhesive layer or sheet 120, and a cover 124. As shown in FIG. 3, the adhesive layer 120 is configured for adhesive attachment to the backing 108, whereby the adhesive layer 120 helps retain the positioning of the antenna elements 116 within the recesses 112. The adhesive layer 120 also conceals or hides the antenna elements 116 (FIG. 18), thereby helping provide a more aesthetic or visual appearance.

The picture frame antenna assembly 100 may be provided in various sizes and shapes. In one exemplary embodiment, the picture frame antenna assembly 100 is configured for holding an 8″×10″ photo, and the picture frame antenna assembly 100 is about nine inches tall by eleven inches wide and one inch deep. These dimensions for the picture frame antenna assembly and photo size (as are all dimensions set forth herein) are for purposes of illustration only as the specific dimensions for a particular application may be changed. For example, other embodiments may include the picture frame antenna being configured for holding other photograph sizes, such as 11″×17″, 5″×7″, 3.5″×3.5″, 3″×5″, 4″×6″, 8½″×11″, 11″×17″, etc.).

With further reference to FIG. 1, the frame or border 104 is generally rectangular with a generally central rectangular opening or window 126. As shown in FIG. 3, the opening 126 is sized such that at least a portion of the adhesive layer 120 is visible through the opening 126. In turn, this means that a photograph or other item will also be visible through the opening 126 when positioned generally between the frame 104 and the adhesive layer 120. Alternative embodiments may include a frame 104 and/or window 126 having a non-rectangular shape (e.g., circular, triangular, square, etc.). Further, the frame 104 and window 126 may also be provided in various sizes depending at least in part on the size (e.g., 3.5″×3.5″, 3″×5″, 4″×6″, 8″×10″, 8½″×11″, 11″×17″, etc.) of the item (e.g., photograph, degree, certificate, document, etc.) to be supported and displayed thereby.

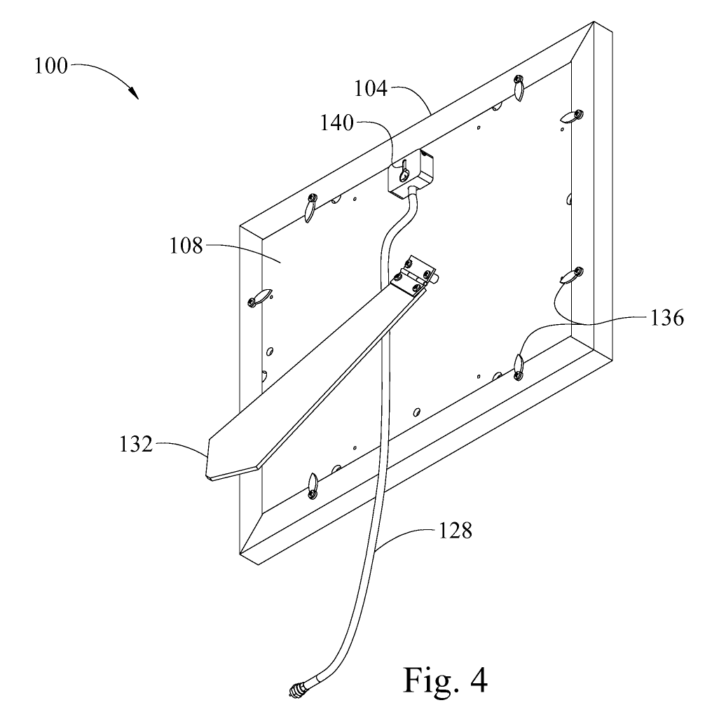

The frame 104 may be coupled to the adhesive layer 120 and/or backing 108 in various ways using various attachment methods or means (e.g., (e.g., adhesives, finishing screws, Velcro® hook and loop closures, magnets, etc.). In the particular illustrated embodiment, tabs, latches, or clips 136 are coupled to the frame 104. As shown in FIG. 4, the tabs 136 may be rotated relative to the frame 104 to engage a back portion of the backing 108, thereby removably attaching the frame 104 to the backing 108. Alternatively other suitable means may also be used for retaining the backing 108 to the frame 104, such as staples, screws, other mechanical fasteners, etc.

A wide variety of materials may be used for the frame 104, including plastics, woods, composite materials, electrically non-conductive or dielectric materials, etc. In one particular exemplary embodiment, the frame 104 is formed from cherry wood, so as to be very elegant and aesthetically pleasing.

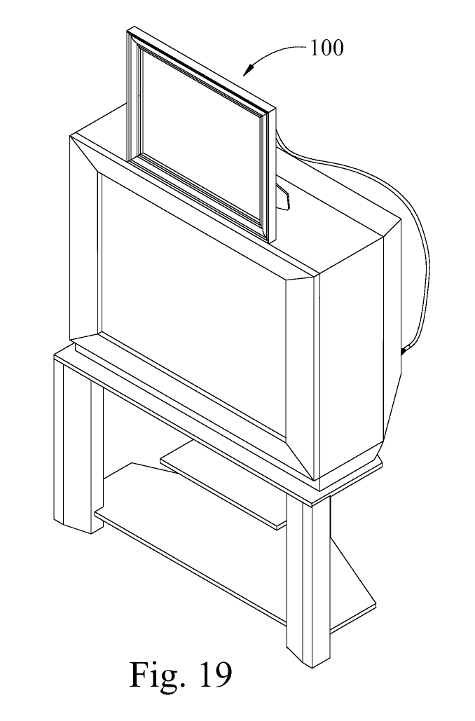

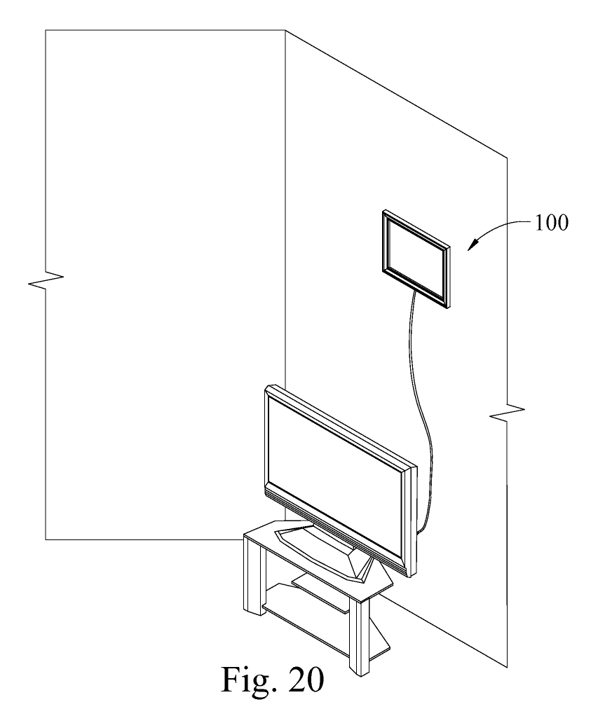

As shown in FIG. 4, a hole 140 is provided for hanging the picture frame antenna assembly 100 from a wall or other support surface (e.g., as shown in FIG. 20). Additionally, or alternatively, the assembly 100 also includes an easel or table mount 132. The easel 132 is pivotable between an open or deployed position and a closed or stowed position. When deployed, the easel 132 may be used to support the picture frame antenna assembly 100 generally upright on a generally horizontal surface (e.g., on top of a television as shown in FIG. 19, a tabletop, coffee tabletop, desktop, shelf, etc.).

But when stowed, however, the easel 132 may be substantially flush with the back of the backing 108. In which case, the easel 132 in the stowed position will not extend outwardly a significant distance beyond the frame's back surface, thereby allowing the picture frame antenna assembly 100 to lay substantially flat against a wall as shown in FIG. 19. For example, the picture frame antenna assembly 100 may be hung from a nail (or other fastener, etc.) driven into the wall and then received within the hole 140. In yet other embodiments, the picture frame antenna assembly 100 may be provided with other suitable support devices.

Additionally, the length of the easel 132 preferably allows the picture frame antenna assembly 100 to lean upon and be supported by the easel 132 at an aesthetically pleasing angle (e.g., an oblique angle, about ninety degrees, etc.) so that a photograph is displayed by the picture frame antenna assembly 100 at an orientation that is in a generally upright or diagonally upwardly direction.

A wide range of materials may be used for the easel 132 including plastics, cardboard, wood, composite materials, electrically non-conductive or dielectric materials, etc. In one exemplary embodiment, the easel 132 is formed from one or more materials so as to provide the easel 132 with a relatively high coefficient of friction. This, in turn, would help the picture frame antenna assembly 100 resist sliding relative to the surface on which the picture frame antenna assembly 100 is being supporting by the easel 132.

In regard to the backing 108, a wide range of materials may also be used (e.g., electrically non-conductive or dielectric materials, soft materials, etc.). In some preferred embodiments, the backing 108 is made of a relatively soft material to prevent, or at least reduce, the possibility of the assembly 100 scratching the surface on which it is placed. In addition, the backing 108 may also be formed from one or more materials so as to provide the backing 108 with a relatively high coefficient of friction. This, in turn, would help the assembly 100 resist sliding relative to the surface (e.g., top surface of television as shown in FIG. 19, etc.) supporting the assembly 100.

With further reference to FIG. 1, the recesses 112 (as defined by the backing 108) are shaped in a manner so as to be consistent with the shape of the corresponding antenna elements 116. In the illustrated embodiments, the two recesses 112 cooperatively define a generally H-shape corresponding to the generally H-shaped cooperatively defined by the two antenna elements 116.

In some embodiments, the recesses 112 are sufficiently deep to allow the antenna elements 116 to be disposed or confined entirely therein. That is, the recesses 112 may each have a depth equal to or greater than the thickness of the corresponding antenna element 116 such that the antenna elements 116 are confined entirely within the overall thickness of the backing 108. This, in turn, would allow a photograph or other item to lay substantially flat against the adhesive layer 120 without interference from the antenna elements 116, since the antenna elements 116 would not be protruding outwardly beyond the recesses 112.

In some embodiments, the recesses 112 are defined so as to form an interference, friction or snug fit with the antenna elements 116. In such embodiments, the interference fit may thus help retain the positioning of the antenna elements 116 relative to the backing 108. Alternatively, the backing 108 may include more or less than two recesses or depressed portions and/or with a different configuration (e.g., different shapes, sizes, positions, locations, etc.) depending, for example, on the particular configuration of the one or more antenna elements to be used. As an example, other embodiments may include a backing without any recesses such that the antenna elements are sandwiched between the backing and the adhesive layer.

As just noted, some embodiments include an interference or friction fit that is formed between the backing 108 and the antenna elements 116 when positioned within the recesses 112. In addition, or as an alternative to such a retention method, some embodiments adhesively attached the antenna elements to the backing 108.

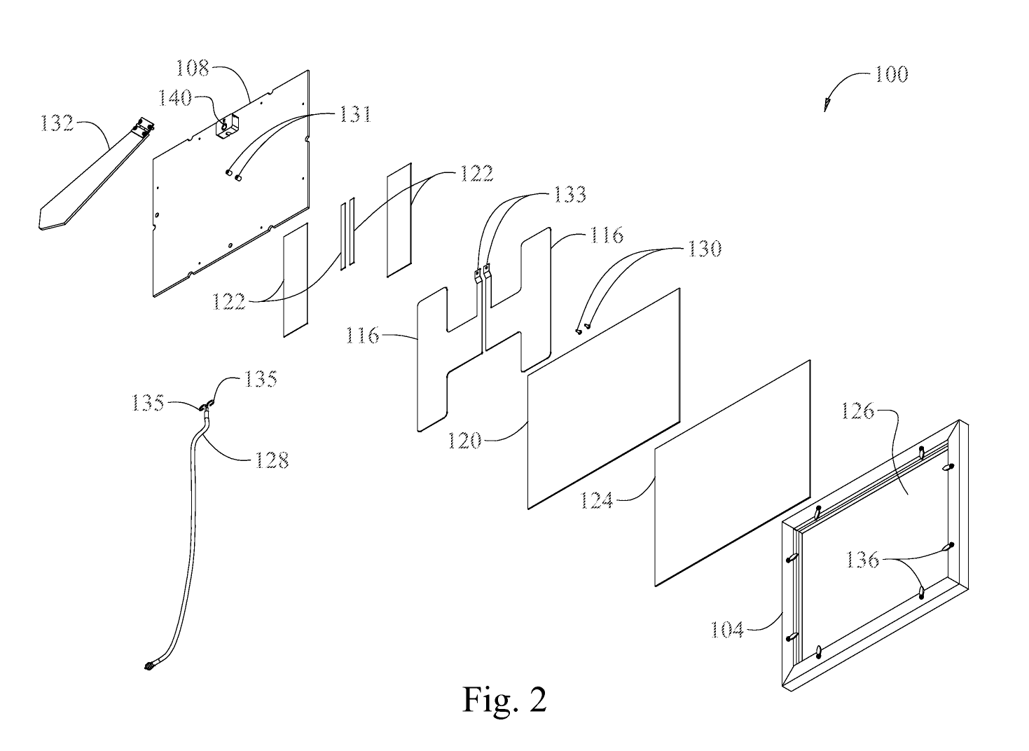

For example, FIGS. 1 and 2 illustrate an adhesive layer or sheet 120 and adhesive strips or patches 122. The adhesive strips 122 are disposed generally between a rear surface of the antenna elements 116 and a bottom surface of the recesses 112. As shown by comparing FIG. 1 with FIG. 18, the adhesive layer 120 is disposed over a front surface of the backing 108 and the antenna elements 116. Accordingly, the adhesive layer 120 and adhesive strips 122 help retain the antenna elements within the recesses 112. In addition, the adhesive layer 120 also hides and conceals the antenna elements 116 from view. In some embodiments, the front surface of the adhesive layer 120 may be decorated to even further enhance the aesthetic appearance and/or commercial appeal of the assembly 100. For example, the front surface of the adhesive layer 120, which will be visible through the cover 124, may be decorated with an image of a HDTV flat panel television in order to emphasize to potential customers that the picture frame antenna assembly 100 has the dual functionality of being a picture frame and a HDTV antenna.

Other embodiments may include only the adhesive layer 120 and not the adhesive strips 122. Still other embodiments may include the adhesive strips 122 but not the adhesive layer 120. Alternative methods may also be employed for retaining the antenna elements within the recesses.

In order to protect the photograph or other item being displayed, for example, from fingerprints, etc., various embodiments also include a protective cover 124. As shown in FIGS. 1 and 2, the cover 124 is positionable generally between the frame 104 and the backing 108. The cover 124 may be formed from a wide range of materials, such as glass, plastic, acrylic materials, electrically non-conductive or dielectric materials, etc. In various embodiments, the cover 124 is formed from transparent glass. Depending on the particular object or item to be displayed by the assembly 100, some embodiments may eliminate and not include any cover 124.

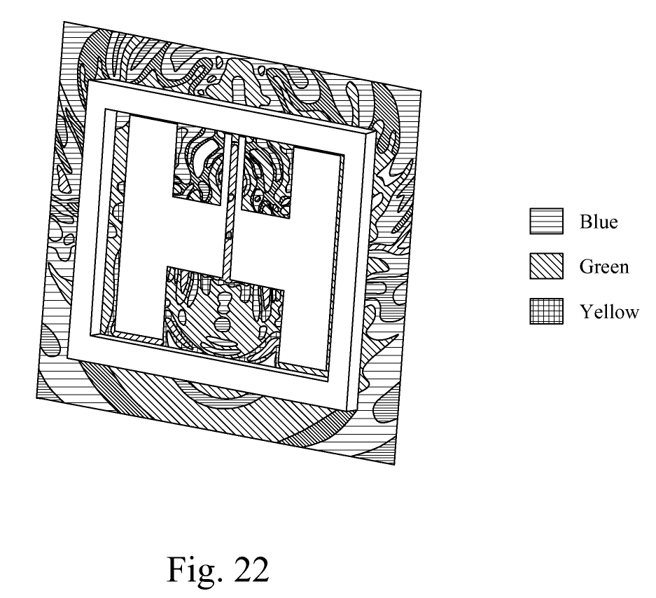

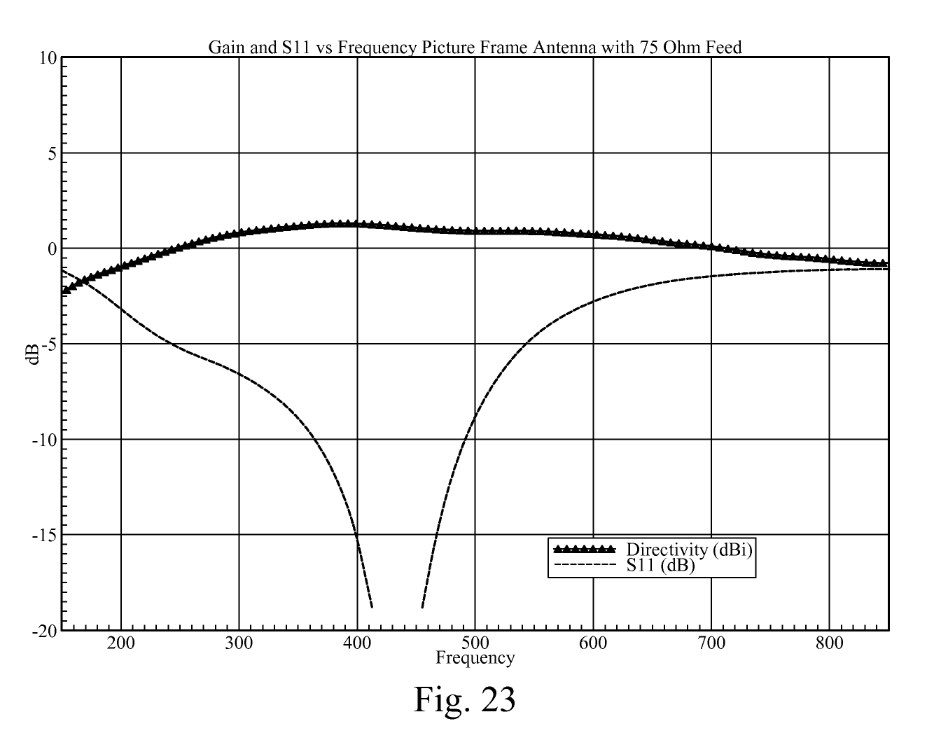

For the exemplary assembly 100 shown in FIG. 1, there are two antenna elements 116 that together cooperatively define a generally H-shape. As noted above, the antenna elements 116 may be configured (e.g., sized, shaped, located, etc.) to be positioned at least partially within the recesses 112 of the backing 108. The recessed portions 112 and antenna elements 116 may be configured to have generally corresponding shapes (e.g., generally H-shaped in this embodiment, etc.) and sizes. Alternatively, the recessed portions 112 do not necessarily have to correspond in shape to the antenna element 116. For example, the recessed portions 112 may instead comprise a rectangular shape or other shape that is sufficiently large enough to receive the antenna elements 116. In some embodiments, the antenna elements 116 may be configured so as to have operational parameters substantially as shown in FIG. 22 and/or FIG. 23. In FIG. 22, the “BLUE” areas represent about −70 decibels, the “GREEN” areas represent about −35 decibels, and the “YELLOW” areas represent 0 decibels.

In various embodiments, the antenna elements 116 is tuned to receive signals having a frequency associated with high definition television or UHF signals within a frequency range of about four hundred megahertz and about eight hundred megahertz. In such embodiments, narrowly tuning the antenna elements 116 for receiving these HDTV signals allows the antenna elements 116 to be smaller and yet still function adequately. With its smaller or discrete size, the antenna elements 116 may be disposed within the recesses 112 of the backing 108 in a manner such that the antenna elements 116 will not interfere or take away from the aesthetically pleasing appearance of the picture frame assembly 100 or interfere with displaying a photograph. For example, the antenna element 116 may in some embodiment be made sufficiently thin to fit entirely within the recess 112 such that the antenna element 116 is confined within the thickness of the backing 108. Accordingly, the antenna element 116 would thus not protrude outwardly beyond the backing 108, which might otherwise inhibit the photograph from lying flat against the adhesive layer 120.

A wide range of materials may be used for the antenna elements 116. In various preferred embodiments, the antenna elements 116 are formed of stainless steel. Alternatively, other materials may also be used.

In the illustrated embodiment, a coaxial cable 128 is used for transmitting signals received by the antenna elements 116 to an external device, such as a television (e.g., FIGS. 19 and 20, etc.) In one example, the coaxial cable 128 is a 75-ohm coaxial cable. Alternative embodiments may include other coaxial cables and other suitable communication links.

Various methods may be used for attaching the coaxial cable 128. As shown in FIGS. 1 and 2, screws 130 are used to attach the coaxial cable 128 to threaded posts 131 (FIG. 2). The screws 130 are received through fastener holes 133 of the antenna elements 116, and then through openings 135 defined by the coaxial cable 128. Alternatively, other means may be used for attaching the coaxial cable 128.

Exemplary operational parameters of the exemplary picture frame antenna assembly 100 will now be provided for purposes of illustration only. These operational parameters may be changed for other embodiments depending on the particular application and type of signals to be received by the antenna.

By way of example, the picture frame antenna assembly 100 may be configured such that it has a range of up to fifteen miles of the transmitter. In other words, the assembly 100 may performs best in strong signal areas, which usually occurs within fifteen miles of the transmitter. This, however, may depend on the particular transmitter that is transmitting the signals received by the assembly 100. Continuing with this example, the assembly 100 may be configured to have a gain of approximately 6.5 decibels and be tuned for receiving signals associated with UHF channels 14 through 69. The assembly 100 may include a cherry wood frame 104 with glass protective cover 124. The assembly 100 may also be configured to support a photograph in landscape orientation, portrait orientation, or both. The assembly 100 may further include a 75-ohm RG6 coaxial cable 124 fitted with F-Type connector (although other suitable communication links may also be employed).

The assembly 100 may be configured or tuned to receive signals having a frequency associated with digital television reception within a first frequency range of about 174 megahertz and about 216 megahertz, and within a second frequency range of about 470 megahertz and about 698 megahertz. The assembly 100 may be configured to have a maximum gain of about 6 dBi (decibels referenced to isotropic gain) above a reference dipole and an output with an impedance of about 75 Ohms.

FIG. 23 is an exemplary line graph of the gain and S11 versus frequency for an exemplary embodiment of a picture frame antenna assembly with seventy-five ohm balanced feed. In other embodiments, a 300 ohm balanced line may be used.

In various embodiments, one or more externally visible portions of a picture frame antenna (e.g., back surface of the backing, front surface of the adhesive layer or sheet, frame member, etc.) may be provided or decorated with a wide range of indicia including advertising content, trademarks, trade names, service marks, graphic images, graphic elements, designs, artwork, distinctive marks, identifying symbols, company logos, company contact information, text, alphanumeric characters, sports team insignias, names, monograms, photographs, among others. For example, the frame 104 may be decorated with textual messages, ornate decorations, etc. Or, for example, the front surface portion of the adhesive layer 120 that is visible through the cover 124 may be provided with an image of a HDTV flat panel television in order to emphasize to potential customers that the picture frame antenna has the dual functionality of being a picture frame and a HDTV antenna. This, in turn, may thus enhance the commercial appeal of a picture frame antenna assembly.

In other embodiments, the backing may be used with different frame configurations (e.g., different shapes, different sizes, different designs, less elegant designs, different materials, etc.) and/or without any frame whatsoever.

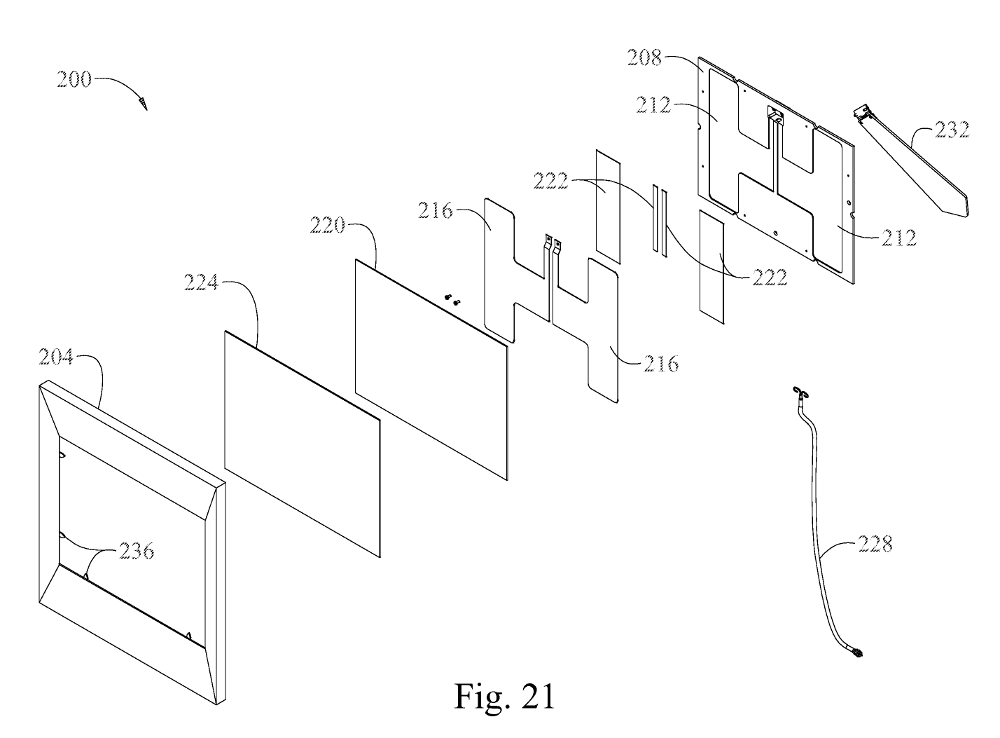

For example, FIG. 21 illustrates another embodiment of a picture frame antenna assembly 200. As shown, the picture frame antenna assembly 200 includes a frame 204, a backing 208 with recessed portions or depressions 212, and antenna elements 216. In this particular embodiment, however, the frame 204 has a different configuration than frame 104. The assembly 200 also includes adhesive layer 220, adhesive strips 222, cover 224, coaxial cable 228, easel 232, and clips 236.

In yet other embodiments, a combination antenna and photograph display device may include a backing with at least one recessed portion in which is positioned at least one antenna element. Such other embodiments may not include any frame or border 104, 204. For example, one such frameless display device may include a backing and antenna elements substantially identical in structure as the backing 108 and antenna elements 116 described above and shown in FIG. 1. In this frameless embodiment, however, the display device may include one or more photomounts coupled directly to an adhesive layer and/or backing.

Other embodiments relate to methods of making and using picture frame antenna assemblies. Various embodiments relate to methods of displaying a photograph while also receiving high definition television signals. In one such embodiment, a method generally includes positioning a photograph generally between a frame and a backing. The frame may be removably attached to the backing. A communication link may be connected to a television for communicating signals to the television that are received by at least one antenna element disposed within at least one recessed portion of the backing.

Embodiments disclosed herein may be used for displaying various objects and items, including photographs, artwork, diplomas, certificates, paintings, etc. Accordingly, embodiments of the present disclosure should not be limited to displaying any one particular type/size/shape of item or object, such as a photograph. Likewise, embodiments disclosed herein may include antenna elements tuned for receiving signals having frequencies not associated with HDTV, such as AM/FM radio signals, etc. Thus, embodiments of the present disclosure should not be limited to receiving only signals having a frequency or within a frequency range associated with HDTV only. Picture frame antenna assemblies disclosed herein may alternatively be used in conjunction with any of a wide range of other electronic devices, such as radios, etc. Therefore, the scope of the present disclosure should not be limited to use with only HDTV televisions.

Terms such as “upper,” “lower,” “inner,” “outer,” “inwardly,” “outwardly,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments of the present invention has been provided for purposes of illustration and description. It is not intended to be exhaustive or to limit the invention to the precise forms disclosed. Individual elements or features of a particular embodiment are generally not limited to that particular embodiment, but, where applicable, are interchangeable and can be used in a selected embodiment, even if not specifically shown or described.

What is claimed is:

1. A picture frame antenna assembly comprising:
a backing defining at least one recess;
a frame removably attachable to the backing for holding a photograph therebetween, the frame having a generally annular shape with an opening through which a portion of the photograph is visible; and
at least one or more antenna element disposed within the recess defined by the backing.

2. The assembly of claim 1, wherein the at least one antenna element is tuned to receive signals having a frequency associated with high definition television.

3. The assembly of claim 1, wherein the at least one antenna element is tuned to receive signals having a frequency associated with UHF.

4. The assembly of claim 1, wherein the at least one antenna element is tuned to receive signals having a frequency from about four hundred megahertz and about eight hundred megahertz.

5. The assembly of claim 1, wherein the at least one antenna element is tuned to receive signals having a frequency associated with digital television reception within a first frequency range of about 174 megahertz and about 216 megahertz, and within a second frequency range of about 470 megahertz and about 698 megahertz, and wherein the assembly is configured to have a maximum gain of about 6 dBi (decibels referenced to isotropic gain) above a reference dipole and an output with an impedance of about 75 Ohms.

6. The assembly of claim 1, wherein the at least one recess is defined by the backing with a shape corresponding to a shape of the at least one antenna element.

7. The assembly of claim 6, wherein the at least one recess and at least one antenna element are generally H-shaped.

8. The assembly of claim 1, wherein the at least one recess is defined by the backing with a depth equal to or greater than the thickness of the at least one antenna element such that the at least one antenna element is confined within a thickness defined by the backing.

9. The assembly of claim 1, wherein the at least one recess is defined by the backing to form an interference fit with the at least one at least one antenna element that helps retain the positioning of the at least one antenna element relative to the backing.

10. The assembly of claim 1, further comprising at least one adhesive layer disposed over a front surface of the backing and the at least one antenna within the recessed portion to thereby help retain the at least one antenna element within the recessed portion and conceal the at least one antenna element.

11. The assembly of claim 1, wherein the at least one antenna element is adhesively attached to the backing.

12. The assembly of claim 1, further comprising at least one adhesive member adhesive disposed generally between a rear surface of the at least one antenna element and a bottom surface of the recessed portion.

13. The assembly of claim 1, further comprising a protective cover positionable generally between the frame and the backing through which at least a portion of the photograph is visible.

14. The assembly of claim 1, further comprising at least one communication link for communicating signals received by the antenna element to an external device.

15. The assembly of claim 14, wherein the at least one communication link comprises a coaxial cable.

16. The assembly of claim 1, further comprising an easel pivotable relative to the backing between a stowed position and a deployed position in which the easel helps support the assembly on a generally horizontal surface.

17. An assembly suitable for displaying a photograph and operable for receiving signals, the assembly comprising:
a backing;
at least one photomount coupled to the backing;
at least one antenna element disposed generally between the backing and the photomount.

18. The assembly of claim 17, wherein the at least one antenna element is tuned to receive signals having a frequency associated with high definition television.

19. The assembly of claim 17, wherein the at least one antenna element is tuned to receive signals having a frequency associated with UHF.

20. The assembly of claim 17, wherein the at least one antenna element is tuned to receive signals having a frequency from about four hundred megahertz and about eight hundred megahertz.

21. The assembly of claim 17, wherein the at least one antenna element is tuned to receive signals having a frequency associated with digital television reception within a first frequency range of about 174 megahertz and about 216 megahertz, and within a second frequency range of about 470 megahertz and about 698 megahertz, and wherein the assembly is configured to have a maximum gain of about 6 dBi (decibels referenced to isotropic gain) above a reference dipole and an output with an impedance of about 75 Ohms.

22. The assembly of claim 17, wherein the backing defines at least one recess in which the at least one antenna element is disposed.

23. The assembly of claim 22, wherein the at least one recess is defined by the backing with a shape corresponding to a shape of the at least one antenna element.

24. The assembly of claim 23, wherein the at least one recess and at least one antenna element are generally H-shaped.

25. The assembly of claim 22, wherein the at least one recess is defined by the backing with a depth equal to or greater than the thickness of the at least one antenna element such that the at least one antenna element is confined within a thickness defined by the backing.

26. The assembly of claim 22, wherein the at least one recess is defined by the backing to form an interference fit with the at least one at least one antenna element that helps retain the positioning of the at least one antenna element relative to the backing.

27. The assembly of claim 22, further comprising at least one adhesive layer disposed over a front surface of the backing and the at least one antenna within the recessed portion to thereby help retain the at least one antenna element within the recessed portion and conceal the at least one antenna element.

28. The assembly of claim 17, wherein the at least one antenna element is adhesively attached to the backing.

29. The assembly of claim 17, further comprising at least one communication link for communicating signals received by the antenna element to an external device.

30. The assembly of claim 29, wherein the at least one communication link comprises a coaxial cable.

31. The assembly of claim 17, further comprising an easel pivotable relative to the backing between a stowed position and a deployed position in which the easel helps support the assembly on a generally horizontal surface.

32. The assembly of claim 17, wherein the photomount comprises a frame removably attachable to the backing for holding a photograph therebetween, the frame defining a window through which at least a portion of the photograph is visible.

33. The assembly of claim 32, further comprising a protective cover positionable generally between the frame and the backing over at least the portion of the photograph visible through window.

34. The assembly of claim 17, wherein the photomount comprises a border removably attachable to the backing for holding a photograph therebetween.

35. The assembly of claim 34, further comprising a protective cover positionable generally between the border and the backing over at least the portion of the photograph visible through window.

36. A method of displaying a photograph and receiving high definition television signals, the method comprising positioning a photograph generally between a frame and a backing, removably attaching the frame to the backing, and connecting at least one communication link to a television for communicating signals to the television that are received by at least one antenna element disposed within at least one recessed portion of the backing, whereby the at least one antenna element is hidden from view.
